(19) United States
(12) Patent Application Publication
(10) Pub. No.: US 2015/0379657 A1
(43) Pub. Date: Dec. 31, 2015

(54) Emergency ride (Transportation)

(71) Applicant: Clarence Theo Nalls, JR., Baker, LA (US)

(72) Inventor: Clarence Theo Nalls, JR., Baker, LA (US)

(21) Appl. No.: 14/545,638

(22) Filed: Jun. 1, 2015

Related U.S. Application Data
(60) Provisional application No. 62/176,072, filed on Feb. 9, 2015.

(51) Int. Cl. G06Q 50/30; G06Q 20/12

(52) U.S. Cl. CPC G06Q 50/30; G06Q 20/127

(57) ABSTRACT

This claim is to provide alternate transportation for it's members who sustain a need for emergency transportation, or alternate transportation due to the members vehicle not being operable or simply wanting alternate transportation. These services would be available to a member who has purchased a membership for the current year. Each year a member would be required to purchase a new membership, or the old one would lapse.

For the convenience of the member, the services would/could be provided thru existing providers.

Thie petent is to provide transportation to the general public via a paid membership on a yearly basis.

This transportation would be provided when the member's transportation is unavailable due to a flat tire; the vehicle not starting; the vehicle killing, or any other emergency causing the member to need emergency and immediately transportation. The transportation would entitle the member to 2-4 free rides per membership year with up to 35 miles with the member paying for any miles over the specified distance.

The transportation would be provided by independent contractors contracted with us(FREE RIDE, INC). Such independent contractors would be Yellow Cab, Checker Cab, Uber, Black & WHite Cab, and any other taxie cab company or transportation companys that may be contracted with.

1. This invention is as no other. It is the first and only one of it's kind. This invention provides for emergency vehicle assistance by way of rides to one's destination up on demand, or when one's vehicle becomes inoperable in emergency situations. Such as, when one's vehicle will not start, or the vehicle kills and the member needs a ride, or just simply needs a ride because that member does not desire to drive at a given time.
In order to qualify for this benefit, the member would be required to purchase a yearly membership for a determined membership fee. This membership fee would entitle the member up to five rides per membership year. A membership year would run from the date the member purchased the original membership fee to the next year or anniversary date. At which time the member would be required to purchase a new membership at the going rate, or the membership would lasp due to nonpayment.
In order to take advantage of the membership package, a member in need of services would call an established number and advise the operator of the need for a ride to a destination. Such ride would be provided within 30-45 minutes. Said member could expect to be driven 35 miles, one-way. Any addition miles would be the responsibility of the member.
For the convenience of the member, services could be provided dim existing vehicle assistance providers such as, Yellow cab, or any other similar service provider.
Each ride by a member is considered one ride. That is if a member is dropped off at their original destination, this is considered one ride. If the member is picked up at his original destination, and returned to the destination that the member first left from, this would be considered another ride which would make 2 rides.
